(19) United States
(12) Patent Application Publication
(10) Pub. No.: US 2007/0250417 A1
(43) Pub. Date: Oct. 25, 2007

(54) Methods and apparatus for determining and using human capital metrics as measures of economic value of persons to an organization

(75) Inventors: Leonard D. Lane, Corona Del Mar, CA (US); Donald E. Packham, Chicago, IL (US); Judson W. Goldsmith, San Francisco, CA (US)

Correspondence Address: BEYER WEAVER LLP, P.O. BOX 70250, OAKLAND, CA, 94612-0250, US

(73) Assignee: HCOM Holdings LLC

(21) Appl. No.: 11/638,319

(22) Filed: Dec. 12, 2006

Related U.S. Application Data
(60) Provisional application No. 60/750,775, filed on Dec. 14, 2005.

(51) Int. Cl. G07F 19/00

(52) U.S. Cl. 705/30

(57) ABSTRACT

Disclosed are methods, apparatus, and systems, including computer program products, implementing techniques for determining and using human capital metrics as measures of the economic value of persons to an organization. The financial state and performance of an organization can be characterized accordingly. One or more data resources storing data associated with one or more persons are accessed. A plurality of fields of the data are selected as cost data of the one or more persons, including direct expenses associated with the one or more persons and indirect expenses associated with the one or more persons. The selected data is retrieved from the one or more data resources. A human capital metric is calculated in accordance with the retrieved data, including summing the cost data to determine a total cost for the one or more persons. A report including the calculated human capital metric is generated and provided.

### REFERENCE TO EARLIER-FILED APPLICATION

The present application claims priority under 35 U.S.C. § 119(e) to U.S. Provisional Patent Application No. 60/750,775, Lane et al., for HUMAN CAPITAL METRICS AND METHODS AND DEVICES OF USING HUMAN CAPITAL METRICS, filed Dec. 14, 2005 (Attorney Docket No. HCOMP001P/HCO.001PR), which is hereby incorporated by reference for all purposes.

### FIELD

The present invention relates to techniques for characterizing the financial state of an organization. In particular, the present invention relates to techniques for determining and using human capital metrics as measures of the economic value of persons to the organization.

### BACKGROUND

Decision making in an organization is often based on the state of financial information for the organization. Thus, it is important that financial information maintained for the organization is current and relevant to the decisions being made. The information should be indicative of the strengths and weaknesses of the organization, so the information is useful in governing the organization. Information that provides reference data for improving various aspects of the performance of the organization is particularly desirable.

Conventional financial metrics exist for measuring performance aspects of organizations, such as companies, dominated by tangible assets. For example, financial reports typically include measures of a company's Gross Profit, Operating Income, and Return on Invested Capital (ROIC). Gross Profit, which is Revenue (i.e., price of goods×volume sold) less the Cost of Goods (i.e., materials, labor, and manufacturing overhead), is a useful measure of production efficiency. Operating Income, which is the Gross Profit less the sales, general, and administrative costs (i.e., indirect expenses), is a useful measure of the efficiency of corporate structures. ROIC, which is the net earnings as a percentage of invested capital, is a useful measure of the efficiency of how investors' capital is being used.

FIG. 1 shows a diagram of a bar graph 100 of an allocation of costs and expenses of an organization, determined in accordance with conventional financial metrics. As shown in FIG. 1, conventional financial measures mix people costs, that is, expenses associated with persons working for the organization, with indirect expenses and Cost of Goods Sold (COGS) data 110. The COGS data 110 includes supplier costs, wages for line workers, and non-administrative costs. Selling, General and Administrative expense (SG&A) data 120 includes indirect expenses for administration, and human resources (HR) expenses for employees. The COGS data 110 and SG&A data 120 provide a general measure of an organization's costs and expenses that blurs people costs with expenses unrelated to people working for the organization.

In organizations not dominated by tangible assets, conventional financial metrics as described above may not be indicative of the efficiency or effectiveness of the operation of the organization. Thus, for example, companies that rely heavily on the skills of persons that work for the organization to generate profits are not adequately measured by the above metrics. For example, conventional financial metrics do not provide measures of an individual's cost and value added to the company or its productivity. As a result, conventional metrics have limited usefulness for managing organizations having humans as its main assets.

For instance, a CEO of an organization may be making HR decisions affecting long-term viability of the business on a daily basis without knowing the long-term effects of individual action on pay, benefits, taxes and margins. One question a CEO might ask is, “If I give a 1% increase in pay, what does it really cost me, now and in the future?” It would be desirable to make such HR decisions within the context of how financials are affected. That is, management wants to know how HR programs relate to business performance.

Very little data has been compiled or analyzed with respect to the productivity of people of an organization, such as its employees. Worker productivity metrics published in the United States, for example, are usually limited to sales per employee and revenue per employee. Occasionally, metrics are calculated on other output per employee measurements and other tangible output measures that are specific to certain industries and/or companies. The banking industry in the United States, for example, publishes some tangible output measures of employee activity.

Across industries and government agencies, data compiled under the auspices of HR departments are not measured, analyzed, nor acted upon in the same way as financial and/or information related to a company's product line or capital expenditures. Thus, for example, the techniques used by companies for financial planning and analysis work that results in the management-discussion-and-analysis section of the company's annual report are not applied to data compiled by the HR department. Significant data that is captured in HR Information Systems (HRIS) is useful in understanding the activities of the people of the organization, however. Human Resources information in both the HRIS and the company's accounting systems do not benefit from the kind of analysis routinely applied to product lines, capital equipment and the entire company in the annual report, the single most widely read document used to understand the company.

While conventional financial state metrics have led to improvement in the operating efficiency and organizational structure in an industrial economy, these metrics have limited relevance and usefulness in a knowledge economy. There are no financial metrics currently available that can be used to understand, analyze, and compare the efficiency with which organizations leverage their employees in a quantifiable economic measure of value. What is needed are metrics that adequately and accurately reflect the financial cost and benefit of the people working for an organization. Such metrics would better inform management decisions made for the organization, as well as create the opportunity to increase shareholder value in the organization.

### SUMMARY

Disclosed are methods, apparatus, and systems, including computer program products, implementing techniques for determining and using human capital metrics as measures of the economic value of persons to an organization.

According to one aspect of the present invention, a computer-implemented method of characterizing the financial state and performance of an organization is provided by measuring the economic value of one or more persons to the organization. One or more data resources storing data associated with one or more persons are accessed. A plurality of fields of the data are selected as cost data of the one or more persons, including direct expenses associated with the one or more persons and indirect expenses associated with the one or more persons. The selected data is retrieved from the one or more data resources. A human capital metric is calculated in accordance with the retrieved data, including summing the cost data to determine a total cost for the one or more persons. A report including the calculated human capital metric is generated and provided.

In one implementation, calculating the human capital metric further includes retrieving a measure of contribution attributable to the one or more persons, and dividing the measure of contribution by the total cost to determine a human capital operating margin for the one or more persons. Examples of suitable measures of contribution include, but are not limited to, an operating income, a market value, and a negotiated transfer price. The data can be accumulated to analyze one or more designated time frames.

In one implementation, the direct expenses include one or more selected from the group consisting of cash remuneration, wages, variable pay, taxes, benefits costs, administrative costs, timing costs, development costs, recruitment costs, relocation costs, severance provisions, training costs, pension costs, and medical expenses. In one implementation, the indirect expenses include one or more selected from the group consisting of office supplies costs, printing costs, shipping costs, property maintenance costs, real estate costs, professional services costs, computing costs, communications costs, transportation costs, and entertainment costs. In one implementation, the cost data includes administrative costs associated with the one or more persons, such as materials costs, services costs, and capital expenses.

In one implementation, the method further includes identifying an attribute of the organization as a target for changing the financial state of the organization, in accordance with the calculated human capital metric. Examples of identified attributes include remuneration, benefits, administrative aspects, training, pensions, real estate, professional services, distributed computing, communications, transportation, entertainment, and various business/production processes. In one implementation, the method further includes performing an intervention event, such as an investment, an acquisition, a divestiture, and a downsizing. In one implementation, the method further includes determining a business outcome in accordance with the intervention event.

In one implementation, the one or more data resources include one selected from the group consisting of a human resources information system (HRIS), an HR database, and a financial database. In one implementation, the data includes employment information, financial data, and/or general ledger data. In one implementation, the one or more persons include a worker, an employee, a contractor, an officer, and/or an agent. In one implementation, the report is a signal. Also, in one implementation, the report is in a suitable format such as a compilation, a graph, and a financial statement component.

According to another aspect of the present invention, a computer-implemented method of characterizing the financial state and performance of an organization is provided by comparing the economic value of persons in the organization. The method includes accessing one or more data resources, storing data associated with a first unit of one or more persons and a second unit of one or more persons. A plurality of fields of the data are selected as first cost data of the first unit of one or more persons and second cost data of the second unit of one or more persons, including direct expenses associated with the one or more persons and indirect expenses associated with the one or more persons. The selected data is retrieved from the one or more data resources. A first human capital metric is calculated in accordance with the retrieved data, including summing the first cost data to determine a first total cost for the first unit of one or more persons. A second human capital metric is calculated in accordance with the retrieved data, including summing the second cost data to determine a second total cost for the second unit. The first human capital metric is compared with the second human capital metric to determine comparison data. A report including the comparison data is generated and provided.

In one implementation, calculating the first human capital metric further includes retrieving a first operating income attributable to the first unit of one or more persons, and dividing the first operating income by the first total cost to determine a first human capital operating margin. In one implementation, the second human capital metric further includes retrieving a second operating income attributable to the second unit of one or more persons, and dividing the second operating income by the second total cost to determine a second human capital margin.

In one implementation, the method further includes identifying an attribute of the first unit or the second unit as a target for changing the financial state of the organization, in accordance with the comparison data. In one implementation, the method further includes performing an intervention event, such as better training, new or modified recruiting efforts, or allocating/re-allocating expenses between the first unit and the second unit. Examples of suitable units of one or more persons include part or all of a division, a department, a team, a group, a module, and a company.

According to another aspect of the present invention, an apparatus is provided for characterizing the financial state and performance of an organization by measuring the economic value of one or more persons to the organization. The organization includes one or more data resources storing data associated with one or more persons. The apparatus includes a data collection module, an analysis module, and a reporting module. The data collection module is coupled to access the one or more data resources, and select a plurality of fields of the data as cost data, including direct expenses associated with the one or more persons and indirect expenses associated with the one or more persons. The data collection module is further coupled to retrieve the selected data from the one or more data resources. The analysis module is coupled to calculate a human capital metric in accordance with the retrieved data, including summing the cost data to determine a total cost for the one or more persons. The reporting module is coupled to generate a report including the calculated human capital metric.

In one implementation, the analysis module is situated on a first server. In one implementation, the data collection module is situated on the first server. In another implementation, the data collection module is situated on a second server in communication with the first server over a network. In one implementation, the reporting module is situated on the first server, while in another implementation, the reporting module is situated on a second server in communication with the first server over a network.

According to yet another aspect of the present invention, a computer-implemented method of affecting the operation of an organization is provided, using financial state information as a measure of the economic value of one or more persons to the organization. The method includes accessing one or more data resources storing data associated with the one or more persons. The data includes cost data for the one or more persons, including direct expenses and indirect expenses. The data is collected from the one or more data resources, and accumulated over a designated time frame. The collected data is filtered, including extraction of the cost data. A first human capital metric is calculated based on the cost data, including summing the cost data, to determine a total cost for the one or more persons. A second human capital metric is calculated based on the first human capital metric, including retrieving an operating income attributable to the one or more persons, and dividing the operating income by the total cost to determine a human capital operating margin for the one or more persons. An attribute of the organization is identified as a target for changing the financial state of the organization, in accordance with the calculated first human capital metric or second capital metric. An intervention event is performed on the identified attribute of the organization.

In one implementation, the method further includes outputting a report indicating the first human capital metric and the second human capital metric. In one implementation, the identified attribute is a business process. In another implementation, the identified attribute is the one or more persons.

All of the foregoing methods and apparatus along with other methods and apparatus of aspects of the present invention may be implemented in software, firmware, hardware and combinations thereof. For example, computer programs embodied in computer-readable media and other products may implement methods of aspects of the present invention. Also, networked computers, servers, and other data processing devices may implement aspects of the invention. These and other features of aspects of the invention will be described in more detail below with reference to the associated drawings.

### BRIEF DESCRIPTION OF THE DRAWINGS

The invention may best be understood by reference to the following description taken in conjunction with the accompanying drawings, which are illustrative of specific embodiments of the present invention.

FIG. 1 shows a diagram of a bar graph of an allocation of costs and expenses of an organization, determined in accordance with conventional financial metrics.

FIG. 2 shows a diagram of a bar graph of an allocation of costs and expenses for determining human capital financial metrics by identifying costs associated with people of an organization, constructed in accordance with one embodiment of the present invention.

FIG. 3 shows a block diagram of a system for determining and using human capital metrics as measures of the economic value of persons to an organization, constructed in accordance with one embodiment of the present invention.

FIG. 4 shows a flow diagram of a method for characterizing the financial state of an organization by determining and using human capital metrics as measures of the economic value of persons to an organization, performed in accordance with one embodiment of the present invention.

FIG. 5 shows a flow diagram of a method for defining data for characterizing the financial state of an organization using human capital metrics as measures of the economic value of persons to an organization, performed in accordance with one embodiment of the present invention.

FIG. 6 shows a flow diagram of a method for collecting data for characterizing the financial state of an organization using human capital metrics as measures of the economic value of persons to an organization, performed in accordance with one embodiment of the present invention.

FIG. 7 shows a flow diagram of a method for analyzing data for characterizing the financial state of an organization using human capital metrics as measures of the economic value of persons to an organization, performed in accordance with one embodiment of the present invention.

FIG. 8 shows a diagram of a bar graph allocating costs and expenses for determining human capital financial metrics by identifying costs associated with people of an organization, constructed in accordance with one embodiment of the present invention.

FIG. 9 shows a diagram of a graphical user interface for monitoring human capital financial metrics characterizing the financial state of an organization, generated in accordance with one embodiment of the present invention.

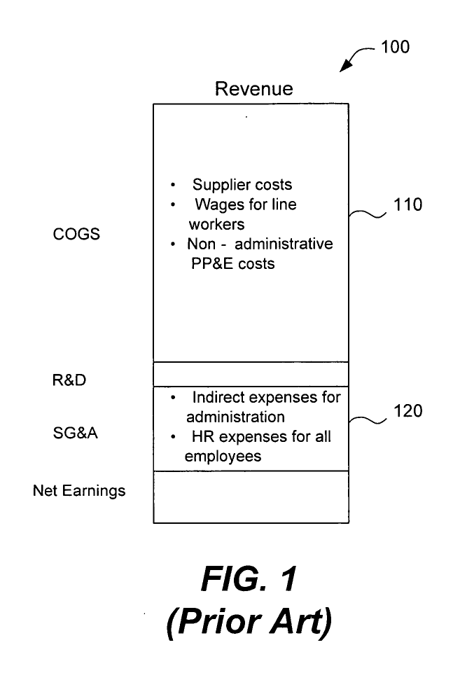

### DETAILED DESCRIPTION

Reference will now be made in detail to some specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. Moreover, numerous specific details are set forth below in order to provide a thorough understanding of the present invention. The present invention may be practiced without some or all of these specific details. In other instances, well known process operations have not been described in detail in order not to obscure the present invention.

Embodiments of the present invention materially add to the tools available for management and financial forecasting by providing metrics that are useful in measuring the current and future cost and productivity of persons as capital in an organization. In one embodiment, the metrics provide for weighing the cost and benefit of workers based on the economic value of their skill sets. The term “worker,” as used herein refers to, without limitation, an individual that provides services to an organization, such as an employee or contractor. The term “organization,” as used herein, refers to, but is not limited to, a company, business, or government agency, or part of a company, business or government agency.

One embodiment of the present invention provides for calculation of one or more metrics indicative of the economic value of persons to an organization from data that has been obtained from an organization. One or more of these metrics, generally referred to herein as human capital metrics, are useful in determining the efficiency of managing organizations, parts of organizations, groups of workers, and individual workers. Examples of human capital metrics, which are not meant to limit the scope of the present invention, include a total cost of employment (TCE), and a human capital operating margin (HCOM). Generally, TCE is a measure of what human resources cost an organization, and HCOM is a measure of what human resources produce for an organization in terms of economic value.

A human capital metric provides a measure of which processes impact human capital performance that can be used to enhance an organization's ability to make targeted interventions that directly affect strategy and business outcomes. Consideration of the level or trend of human capital metrics and the quantities that go into their calculation provide a cost-effective, auditable measurement and management system linking human capital performance on key metrics to operating results. Human capital metrics also leverage the value of people-oriented activities to build intellectual, brand and physical assets, and provide for the partnering of Finance and HR to make investment in human capital a platform for sustained economic growth.

A human capital metric may permit a better understanding of how workers cost and make money for an organization, how to better determine worker performance, and how to recognize and reward performance in order to sustain it. Human capital metrics can also be used to facilitate strategic transformation of organizations to take advantage of technology and tacit knowledge that can be harnessed into more innovation and effective activities. Other uses of human capital metrics in accordance with embodiments of the present invention relate to HR determinations. For example, managers can make decisions as to the long-term effects of individual actions on pay, benefits, taxes, and margins. The use of human capital metrics incorporates financial aspects of the decisions into the metrics, thus permitting management to better understand and predict the HR impact on the organization's finances.

One embodiment of the present invention provides for collection of data that may be used to calculate one or more human capital metrics for an organization. Some or all of the data may be obtained from the organization's financial records. Additionally, some of the data needed to calculate human capital metrics may be available in Human Resources (HR) records and/or from an HR Information System (HRIS). In such cases, one embodiment of the invention provides obtaining data from a financial database and an HR database. Data may be drawn from, but not limited to, electronic files, material stored in file cabinets or records kept in other locations by or on behalf of the organization of interest. Data may also be drawn from other locations, including but not limited to, files maintained by sales and customer service departments, HR outsourcing providers, and corporate auditors/accountants. Additionally, data may be drawn from outside the organization such as, but not limited to, industry associations, other companies, government agencies and material published in the press.

One embodiment of the present invention provides a computer system to accumulate data for the calculation of one or more human capital metrics. The computer system is provided with programming instructions to query one or more databases containing the information and a memory to store the information. The computer system may be the system containing one or more of the queried databases, or may be in electronic communication, such as over a network, with the database(s). The computer system retrieves data to compute one or more human capital metrics. The data may be retrieved from a database or from a memory containing previously stored data.

In one embodiment, the computer system further includes programming instructions, obtained through computer readable media or through a computer network, that instruct the computer system to calculate one or more human capital metrics. Programming instructions provide for accumulating data for the calculation of one or more human capital metrics. The programming instructions may be included or provided to the system containing one or more of the queried databases, or may be in a system or provided to a system in electronic communication, such as over a network, with the databases. Programming instructions are configured to retrieve data to compute one or more human capital metrics.

Human capital metrics can be computed for organizations of various structures and sizes, for example, organizations having between 500 and 25,000 workers, although embodiments of the invention are applicable to smaller and larger organizations.

The metrics, methods, apparatus, and systems of embodiments of the present invention provide an orderly and broad application of quantitative analysis focused on human capital resources as a separate productive resource. The methodology of the present invention is quantitatively based, repeatable, and auditable. It is expected that data may be drawn from the traditional financial accounting system of the company, human resource files and any other sources relating to the productivity of human capital. In one embodiment, one or more human capital metrics are reported in graphical form. In another embodiment, human capital metrics are reported as a quantitative compilation. In yet another embodiment, one or more human capital metrics are reported as part of a financial reporting system.

In one embodiment, human capital metrics are used as a forecast of change so that metrics can be applied to controlling an organization, i.e., in the form of interventions. In another embodiment, the data includes forecast data from sources beyond the organization of interest, including but not limited to, government agencies, trade associations, other companies, and the press.

One example of a human capital metric determined in accordance with embodiments of the present invention is the Total Cost of Employment (TCE). Generally, the TCE is the sum of costs and expenses of having a worker or a group of workers on the job. Using data mining techniques described herein, the TCE can be computed for a single worker, a group of workers, an average worker, an organization, or some part of the organization. A second example of a human capital metric determined in accordance with embodiments of the present invention is the HCOM, generally defined as operating income, or a similar measure of productivity such as a market or negotiated transfer price, attributable to one or more persons, divided by the TCE for those persons. Examples of operating income include, but are not limited to, calculations made following guidelines described as conforming to Generally Accepted Accounting Principles (GAAP).

Embodiments of the present invention provide for TCE and HCOM to be monitored and compared over designated time intervals, such as quarters, and compared against other organizations and industries relevant to the organization for which the human capital metrics are determined. Using TCE and HCOM, for example, a company's financial state can be benchmarked against best in class companies, and will yield performance improvement opportunities leading to increases in shareholder value.

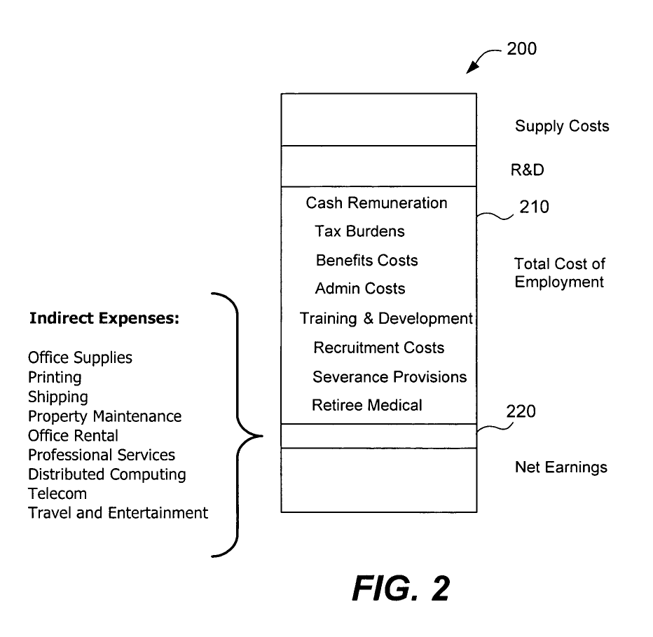

FIG. 2 shows a diagram of a bar graph 200 of an allocation of costs for determining human capital financial metrics, constructed in accordance with one embodiment of the present invention. The bar graph 200 identifies people-based costs in terms of direct and indirect expenses, for an accurate representation of the TCE. In FIG. 2, the TCE is separated from COGS data and SG&A data for a more accurate cost of employment calculation. That is, the TCE is broken out from traditional groupings of direct and indirect expenses for the organization.

In FIG. 2, in one example, the TCE includes direct expenses 210 for one or more persons of the organization including cash remuneration, tax burdens, benefits costs, administrative costs, training and development, recruitment costs, severance provisions, and retiree medical costs. This grouping of direct costs 210 for human capital is by no means definitive or exhaustive. Various costs directly associated with workers of an organization can be identified and selected in direct costs 210 as contributing to the TCE, depending on the particular implementation.

In FIG. 2, separate from the direct expenses 210 are indirect expenses 220, which can be allocated as TCE costs, or non-TCE costs, depending on the desired implementation. For example, indirect expenses 220 can include office supplies, printing, shipping, property maintenance, office rental, professional services, distributed computing, communications, and travel and entertainment expenses. In FIG. 2, the diagram shows an allocation of direct expenses 210 and indirect expenses 220 to separate the elements of the TCE needed to reflect on people costs for an organization. Starting with the TCE, human capital analysis, as described herein, can be performed to target specific areas and processes for improvement.

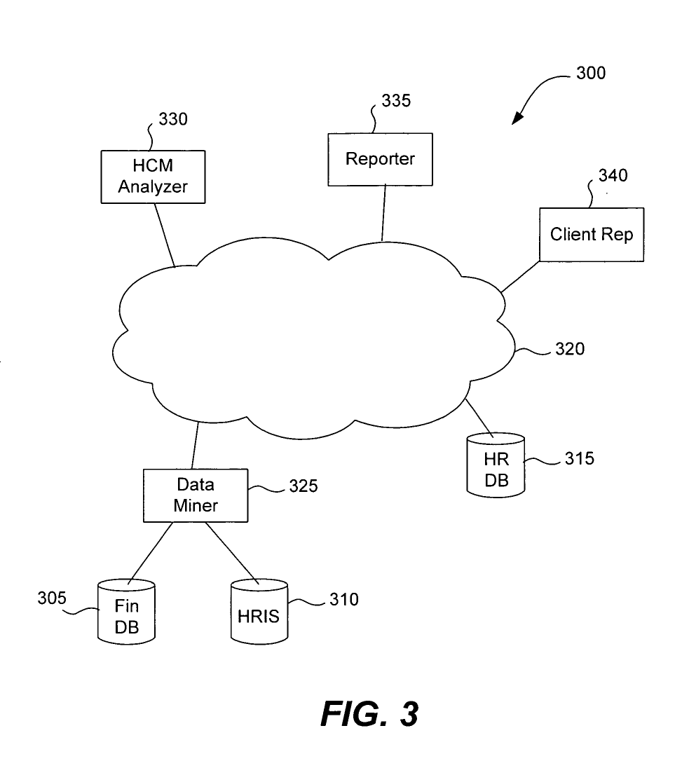

FIG. 3 shows a block diagram of apparatus 300 for determining and using human capital metrics as measures of the economic value of persons to an organization, constructed in accordance with one embodiment of the present invention. The apparatus 300 includes one or more data resources, including a financial database (DB) 305, a HRIS DB 310, and an additional HR DB 315, all in communication with a data network 320. In one embodiment, each data resource stores data associated with one or more persons of the organization. The data resources generally contain, or are provided to contain, data for computing human capital metrics, as described herein. In FIG. 3, for example, financial DB 305 includes general ledger data, while HR DB 315 includes HR data. In one implementation, HR DB 315 stores electronic records with data organized in fields pertaining to individual persons of the organization.

In FIG. 3, a data miner 325 is coupled to network 320. The data miner, implemented in software and/or hardware, is programmed with instructions to query the various data resources for data to compute human capital metrics. The data miner 325 can query databases 305 and 310, with which data miner 325 is in direct communication, as well as HR DB 315, with which data miner 325 is in communication over network 320. In particular, the data miner 325 is coupled to access the various data resources, select certain fields of data in the resources as cost data associated with one or more persons of the organization, and retrieve the selected data from the appropriate data resources. For example, selected data can include direct expenses associated with one or more persons of the organization.

In one embodiment, one or more of the data resources 305, 310, and 315 are situated at remote locations with respect to data miner 325. Thus, for example, a data miner 325 situated at an off-site location can monitor and extract data from databases situated at the organization, and at various remote locations, all accessible over a network 320 such as the Internet.

In FIG. 3, a human capital metric (HCM) analyzer, implemented as software, hardware, or a combination thereof, is coupled to receive the selected data from data miner 325 and calculate a human capital metric in accordance with the retrieved data. For instance, HCM analyzer 330 is coupled to sum the cost data to determine a TCE for one or more persons. In another example, HCM analyzer 330 is operable to calculate an HCOM for the persons, as defined above.

In FIG. 3, the analyzed data from HCM analyzer 330 is provided to a reporter module 335, which is configured to generate and output a report including the calculated human capital metrics. The reporter module 335 is capable of reporting the one or more human capital metrics and other information in various formats, including a tabular report, a graphic display, and a financial statement element. Reporter module 335 is capable of generating, outputting, and displaying the report. In one embodiment, a client representative 340 operating a computer coupled to data network 320 is provided with access to reporter module 335 to view the report, for instance, on an HTML page. The report output by reporter module 335 can be displayed on a computer display, printed in a report, and stored in a computer system or computer readable media for later access and use.

In FIG. 3, the data miner 325, HCM analyzer 330, and reporter 335 can be implemented in software, hardware, and combinations thereof. Moreover, the various modules 325, 330, and 335 can be implemented on a single computer or data processing device, in one embodiment, or on separate computers and/or devices in communication with data network 320, as desired for the particular implementation. In addition, the various modules 325, 330, and 335 can be distributed and situated at various locations of the network 320. For instance, in one embodiment, a first data miner module is situated at a local location with respect to financial DB 305. A second data miner is situated at a remote location and coupled to HR database 315, for instance, in a separate division of a corporate headquarters.

In one embodiment, the HCM analyzer 330 is implemented on a separate computer network or device, such as a remote server with respect to data miner 325. By the same token, reporter module 335 can be implemented on a further computer or data processing device, such as a handheld portable device, in wireless communication with data network 320. Alternatively, reporter module can be implemented as a software component on the same server as HCOM analyzer 330 and/or data miner 325, depending on the desired implementation. Other embodiments of the invention include data processing devices, such as computers, implementing combinations of data miner 325, HCM analyzer 330, and reporting module 335.

The data resources 305, 310, and 315, described herein, can be implemented on any suitable storage media, including, but not limited to, databases and computer readable media such as a CD-ROM, a CD/DVD reader, a removable memory, a hard disc memory, and combinations thereof. In addition, the data resources, represented as databases 305, 310, and 315 in FIG. 3, can alternatively be implemented as resident memory on computers of an organization, such as a financial computer, or HR computer. The data supplied and stored in the various data resources can be keyed into the respective computers, for example, or supplied on computer readable media. Alternatively, the data may be obtained from another computer system in communication with data network 320.

Alternative embodiments of apparatus 300 include implementing the data miner 325, HCM analyzer 330, and reporter 335 as software, residing on the same computer as the data resources 305, 310, and 315, or any portion thereof residing on the same computer as the resources 305, 310, and 315. In another embodiment, the data in databases 305, 310, and 315 is distributed across a plurality of databases, serving as a single data resource. Data can be transferred between the data resources using various software programs, and by various computer media.

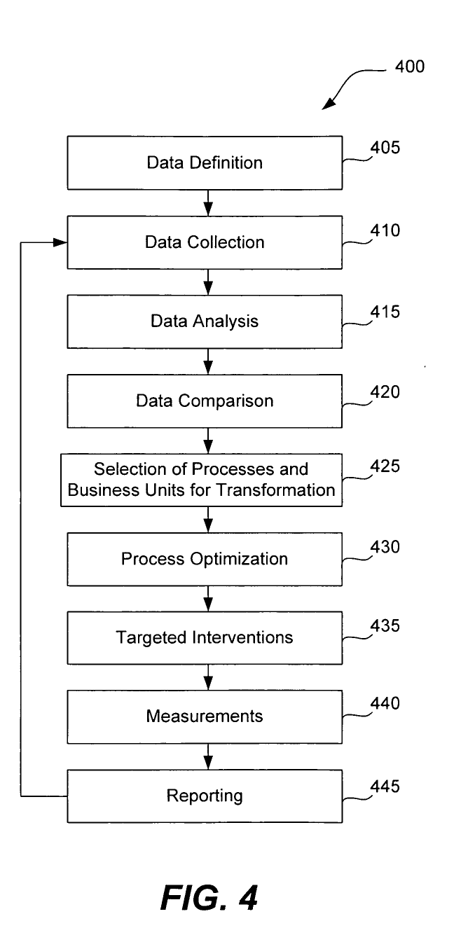

FIG. 4 shows a flow diagram of a method 400 of characterizing the financial state of an organization by measuring the economic value of one or more persons to the organization, performed in accordance with an embodiment of the present invention. The method 400 includes steps that can be taken to affect the operation of the organization using the financial state information. In one embodiment, the method 400 is performed, at least partially, by apparatus described above with respect to FIG. 3. One or more steps of method 400 can be omitted, repeated, and performed at intervals, as desired for the particular implementation.

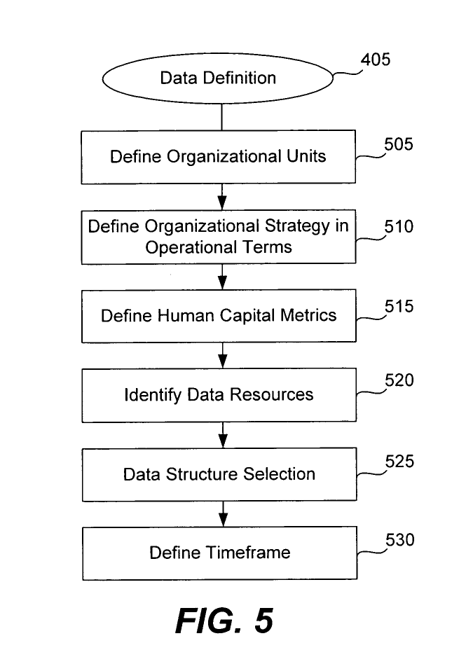

In FIG. 4, the method 400 begins in step 405 in which data is defined and identified for collection and use by components of the data monitoring and analysis apparatus, such as apparatus 300 of FIG. 3. In one embodiment, the definition of data in step 405 includes a number of preparations, described with respect to FIG. 5, to set up data for delivery.

FIG. 5 shows a flow diagram of a method for defining data for characterizing the financial state of an organization, performed in accordance with an embodiment of the present invention. In step 505, the data definition includes defining organizational units, for instance, such as divisions of a company. Other suitable organizational units identified for processing in step 505 can include one or more persons, in various teams or groups within an organization. In one example, step 505 also includes identification of possible business processes and strategic business units within an organization that may later be targets for transformation, as described herein.

In FIG. 5, the data definition method 405 continues in step 510, in which organizational strategies are defined in operational terms. As part of step 510, it is desirable to determine whether strategic business units are revenue generating, and to identify those revenue numbers. It is also desirable that strategic business units be defined in consistent terms as the organizational units defined in step 505. Defining the organizational strategy, in step 505, often includes a general review of client strategies, client operations, and client organization, where “client” refers to the organization for which the data is being defined.

In FIG. 5, the data definition method 405 also preferably includes the definition of human capital metrics, in step 515. For instance, in some implementations, TCE is the only metric of concern. In other implementations, HCOM is the primary metric of concern. In further implementations, both TCE and HCOM are separately of interest. When one or more of these human capital metrics are selected and identified in step 515, the particular data structures, such as costs, that go into the various metrics, are also identified. Then, the particular costs can be selected and retrieved from the various data resources.

In FIG. 5, the data definition method 405 further includes identification of data resources where cost data and other information of interest can be retrieved, in step 520, such as financial database 305 and other databases 310 and 315, in FIG. 3. Identification of the data resources often includes, for example, identifying the general ledger. In addition to being the principle database for a company's accounting system, the general ledger provides information describing the accounting system used by the organization, as well as provides structural information for the data. For instance, a client may organize the ledger so that each line provides an account code for the company, division, and cost account. Also, identification of data resources in step 520 can include location and processing of a codebook or data dictionary that explains codes for various departments or other units in an organization, and for each account.

In FIG. 5, the data definition method 405 proceeds to step 525 in which data structures are identified, that is, fields of data in the data resources are selected for use in human capital metrics computations. For instance, data of interest can include revenue information, such as sales and freight costs, and intra-firm transfer pricing. In addition, data structures of interest can include various cost data to be taken into account when performing a TCE calculation, including fields of data identifying labor costs, such as wages and benefits, and other HR costs including cash remuneration, tax burdens, benefits costs, administrative costs, training and development, recruitment costs, severance provisions, and retiree medical costs.

In addition, in step 525, indirect expenses to be considered for a TCE calculation can be identified, and often depend on the client's industrial sector. For example, laptops and other portable computational devices supplied for employees would be considered an indirect TCE category, as well as utilities for an office. Data structures selected in step 525 can also include materials costs, including direct material costs, and the cost of materials that go into inventory, works in progress, and scrap as part of the HCOM calculation. Other cost data structures can be identified, to provide a residual category for costs not already accounted for in direct and indirect expenses, and the other categories described above.

In FIG. 5, the data definition method 405 also includes a timeframe definition in step 530. Preferably, in step 530, time periods to be covered are established, for instance, in terms of representative quarters. Also, in step 530, it is desirable to identify information unique to the selected quarters, for instance, such as inventory logging issues, hiring or downsizing events, and other concerns that provide information unique to the selected timeframes. Preferably, in some embodiments, the time period provides a snapshot of typical or average organization finances during a defined timeframe. In step 530, preferably the data identified in step 520 is organized by the defined time period, such as per quarter. For instance, a separate worksheet can be maintained for each timeframe. In one implementation, a pivot table is provided on each worksheet for each category of information. A cell or field in the table can refer to a chart of accounts to determine whether the account is relevant to provide cost data and other information of interest to the data collection.

Returning to FIG. 4, following the data definition step of 405, the data is collected in step 410. For instance, data identified in the fields of HR records and other selected documents of step 405 are designated as cost data and pulled from the various data resources in which the data is stored. In one embodiment, data miner 325, in the apparatus 300 of FIG. 3, performs the data collection step 410. In one implementation, data miner 325, after retrieving the data of interest, constructs cost data records and files to appropriately categorize the retrieved information, and stores the information locally in a suitable storage medium accessible by data miner 325.

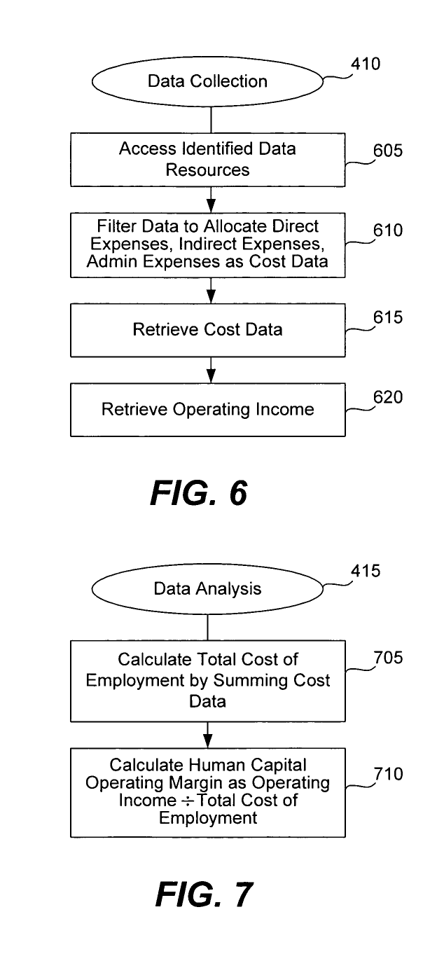

FIG. 6 shows a flow diagram of a method for collecting data for characterizing the financial state of an organization using human capital metrics, performed in accordance with an embodiment of the present invention. In step 605, the data collection method 410 begins, with accessing the identified data resources, as described above. In step 610, the data of interest are selected and filtered accordingly to identify and allocate direct expenses, indirect expenses, administrative expenses, and other items of interest as cost data. In step 615, the data of interest, particularly cost data, are retrieved. In addition, for an HCOM calculation, in step 620, the operating income attributable to the defined units of persons is retrieved. Such information can be provided, for example, in financial database 305 of FIG. 3.

Returning to FIG. 4, following data collection step 410, the method 400 proceeds to data analysis, in step 415. In one implementation, as described above with reference to FIG. 3, the HCM analyzer 330 performs the data analysis of step 415. In one implementation, categories of cost data for each department or other defined unit is summarized using pivot tables, as described above, for the defined timeframe. Preferably, TCE data are identified, gathered and verified. Also, in one implementation, TCE is defined on a per person basis, wherein the TCE for a defined unit of persons is divided by the head count of persons in the unit. Those skilled in the art should appreciate that head counts can be difficult to obtain, due to turnover and transfers among business units, and in one implementation, are averaged over a time period, or estimated.

FIG. 7 shows a flow diagram of a method 415 for data analysis for characterizing the financial state of an organization using human capital metrics, performed in accordance with an embodiment of the present invention. The data analysis method 415 includes calculating one or more human capital metrics for the identified and selected cost data, as described above. Preferably, in some implementations, expenses are allocated not only by direct or indirect categories, but also in terms of identified units of individuals and even product lines. The TCE is then calculated for the identified units and product lines. Employee cost data can also be allocated by internal costs and supplier costs.

In FIG. 7, the TCE is calculated for an identified one or more persons in step 705. The TCE calculation is performed in accordance with a defined allocation of expenses, as explained above with reference to FIG. 2, such as a determination as to whether to include direct expenses, indirect expenses, and administrative costs.

In FIG. 7, the data analysis method 415 continues to step 710, in which HCOM is calculated using the operating income data and a TCE calculated for a person and/or group of persons. In particular, the HCOM is determined by dividing the operating income attributable to the business unit by the TCE associated with that business unit. Thus, HCOM margins can be determined for identified individuals or groups of individuals within an organization, and later compared. In one implementation, HCOM is the net operating income for a strategic business unit divided by the TCE for that business unit, where the net operating income is revenue less costs.

Returning to FIG. 4, when TCE and HCOM metrics are determined in step 415, the metrics for particular units within an organization or among different organizations can be compared, in step 420. For instance, a first HCOM can be calculated for a first unit of one or more persons, and a second HCOM can be calculated for a second unit of one or more persons. The first and second HCOMs can then be compared with one another. For instance, by comparing HCOMs, management of a business has another metric to determine which organizational unit or units are operating at higher efficiency and productivity levels. In one implementation, such human capital metrics are determined on a per person basis to identify variations in the performance of persons within a particular unit.

In FIG. 4, following step 420, the method proceeds to step 425, to select processes and business units as targets for transformation. For instance, depending on the numbers returned for TCE and HCOM for various business units, certain elements of those units, such as areas of high cost, can be identified as areas for change. In addition, the units of persons themselves can be identified as problematic or in need of structural change.

In FIG. 4, in step 430, the method 400 provides for optimization of the selected processes and business units identified in step 425. Various attributes of the organization can be changed to optimize performance of the organization. Such attributes include direct and indirect costs included in the TCE calculation, and various changes to groups or units. As part of process optimization in step 430, selected attributes of an organization are identified and can be further monitored.

In step 435 of FIG. 4, targeted interventions can be performed on the identified attributes in steps 425 and 430. Examples of targeted interventions, performed in accordance with aspects of the present invention, include, but are not limited to, new training plans, new recruitment focus, sourcing projects, demand management, business process and organizational redesign, selective outsourcing, and compensation policies taking TCE into account. Variable pay schemes can be implemented rewarding improvement in HCOM. Targeted interventions can result in significant reductions in expenses. In addition to reducing costs, application of human capital metrics in accordance with embodiments of the present invention provide for direct impacts on the business planning process as well as future policy. Beyond savings, planning, and policy impacts, targeted interventions can include data driven downsizing and redeployment decisions, as well as production improvements, revenue generating improvements and dividend policy changes.

In FIG. 4, in step 440, measurements, preferably in the form of regular monitoring, are performed on the TCE, HCOM, and any other human capital metrics determined in accordance with aspects of the present invention. That is, following a targeted intervention of step 435, it is desirable to monitor the effect of that intervention on the TCE and HCOM over the next designated timeframe. In one implementation, a graphical user interface is generated on a suitable display screen to provide regular updating of HCOM and TCE metrics. In this way, management can effectively monitor the effects of targeted interventions on particular attributes contributing to the calculation of those metrics. Measurement activities include determining changes in metrics over time, identifying outliers in data returned over a designated timeframe, and determining whether certain targeted interventions may be more effective in achieving business goals.

In FIG. 4, in step 445, reports of the metrics, including TCE and HCOM, as well as monitoring data, can be output and provided for later analysis. The reports can be formatted as compilations, graphs, and financial statement elements. By providing reports in step 445, management of an organization can identify opportunities for revenue enhancements, cost savings, cost avoidances, productivity improvements, policy changes, process improvements, and governance steps, including those described above as targeted interventions in step 435. In one embodiment, reporter module 335 of FIG. 3 performs the reporting of step 445.

In FIG. 4, following the reporting step 445, the method preferably returns to data collection step 410 to repeat steps 410-445 over regular timeframes. In this way, the method 400 provides a continuous improvement cycle to assist management with realigning human capital with organizational strategies. The method 400 provides for calculation and re-calculation of TCE and HCOM, as well as showing how the human capital metrics change over time. Thus, management is allowed to compare the human capital metrics across divisions or other suitable units, and in some embodiments, compare those metrics against other organizations as benchmarks.

Returning to FIG. 5, in step 525, data structure selection varies, depending on the organization and arrangement of data resources. In one implementation, data structures of interest include financial statements, for instance, organized by quarter, narrative reports related to the financial statements, charts of account including information indicative of the content of individual accounts, general ledger information, data dictionaries, salary information, head count, service level agreements, copies of other reports used to run the organization, and other data files and records. In particular, the general ledger over a designated timeframe includes detailed data including source transactions. Thus, general ledger data provides for monitoring trends, adjustments to compensate for inconsistencies, and other elements of performance for accurate calculation of human capital metrics. Salary information can be organized by department and location for each quarter. In one implementation, salary information is retrieved by time period, by department, by employee number, and then calculations can be made for work teams or other units.

In FIG. 5, in step 525, head counts can be determined at quarter ends for each department and location over a designated timeframe. In one implementation, head counts are calculated in terms of employees working hours per week. For instance, one employee is defined as one full-time equivalent working 40 hours per week. Overtime of exempt employees is generally not counted in the full-time equivalent calculation. Overtime of non-exempt employees is aggregated as additional full-time equivalents. Part-time employees and contractors are aggregated as additional full-time equivalents. Data can be requested from a contracted payroll service if not readily available internally.

As mentioned above, the HCOM metric is calculated as the operating income attributable to a unit of one or more persons divided by the total cost of employment of that unit of one or more persons. For example, during a designated timeframe of a quarter, Q1, an organization invests approximately 6 million dollars in a unit as costs, and earns an operating income return for that unit of about 10 million dollars. Thus, in essence, the organization paid out approximately 6 million dollars to have the employees in the unit employed, which was the total cost of employment. The organization got back their 6 million dollar investment, plus 4 million dollars, for a total of approximately 10 million dollars, or a human capital operating margin of approximately 167%.

In another example, the TCE is calculated for a particular person, in this case, an individual management employee. Applying the TCE calculation described above, it is determined that the management employee has a TCE of $192,500 with a base salary of $100,000. Thus, the TCE is 92.5% over the base salary, much higher than the organization had originally forecast. This finding enables development of a number of optimization strategies regarding development, compensation, and productivity as well as cost reduction strategies relating to elements of the TCE.

In another example, TCE and HCOM metrics are calculated across five divisions of a corporation, as shown in Table 1.

TABLE 1
HCOM Comparison across Divisions for a Quarter

| CAC | | | | |
|---|---|---|---|---|
| Corporation | Total | Operating | Total Cost of | |
| Q1, 2005E | Revenue | Income | Employment | HCOM |
| Division 1 | 25,392,443 | 9,886,512 | 6,242,062 | 158% |
| Division 2 | 1,028,618 | 298,738 | 256,526 | 116% |
| Division 3 | 2,665,734 | 1,826,567 | 667,539 | 274% |
| Division 4 | 3,821,410 | 1,254,478 | 1,154,948 | 109% |
| Division 5 | 3,556,981 | (188,547) | 2,589,877 | (7%) |

In Table 1, HCOM is compared across divisions of an enterprise for a quarter, to highlight differences in the productivity of the particular divisions of the corporation. For instance, using the numbers above, an analysis of HCOM numbers leads to a recommendation to change the manufacturing processes, as well as examine staffing and training issues in division 5. Also, divisions 4 and 5 are examined for possible anomalies as they produce similar products.

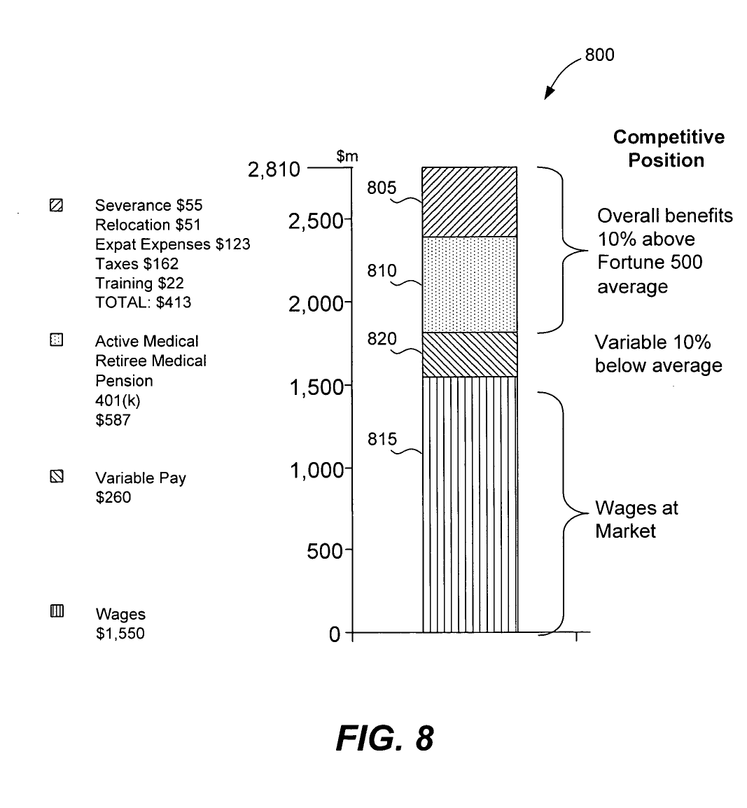

In another example of a TCE calculation, as shown in FIG. 8, the TCE metric includes the HR costs directly assigned to each employee and not the cost of the HR processes or indirect costs that support human capital. This metric reveals that the TCE divided up by severance, relocation, active medical, retiree medical, variable pay and wages, etc., is greater than originally expected. Examination of the TCE metric also reveals that a 1% increase in base pay actually results in a 1.6% total increase. The 1.6% total increase is calculated by adding the top two components 805 and 810 of the bar chart of FIG. 8, $413 and $587, to the bottom component 815, wages of $1,550, totaling $2,550 and dividing the total by the wages of $1,550. The result is 1.645%, rounded to 1.6%. The third component from the top in the bar chart of FIG. 8, variable pay 820, is not included in the calculation, as it is not guaranteed when a raise is given and thus does not have a certain impact on the company's margins.

Focusing solely on the total cost of employment and not employment costs as a part of the larger costs, such as cost of goods sold, can lead to closer scrutiny of employment costs. For example, benchmarking can show the overall benefits of the company are 10% over industry average, while variable pay is 10% below the average. Wages are at market. The determined metrics are useful in providing guidance in setting policies that optimize the performance of the company's human capital. Getting measurable benefit from pay increases, finding cost savings and ways to avoid costs, all play roles in improving the effectiveness and innovation in the corporation.

Various business outcomes can be implemented from application and use of the human capital metrics described above, including comparison of business unit performance to employee payouts, calculating more accurately the units true costs to see true margins, policy changes in retiree medical benefits for new hires, funding of pensions within a financial framework, wage growth viewed against inflation, business units instructed in total costs of pay raises, business plan and forecast readjustments to reflect more accurate data for cash and accrued expenses, trusts enhanced to provide for future retiree expenses, and HR administrative cost implications.

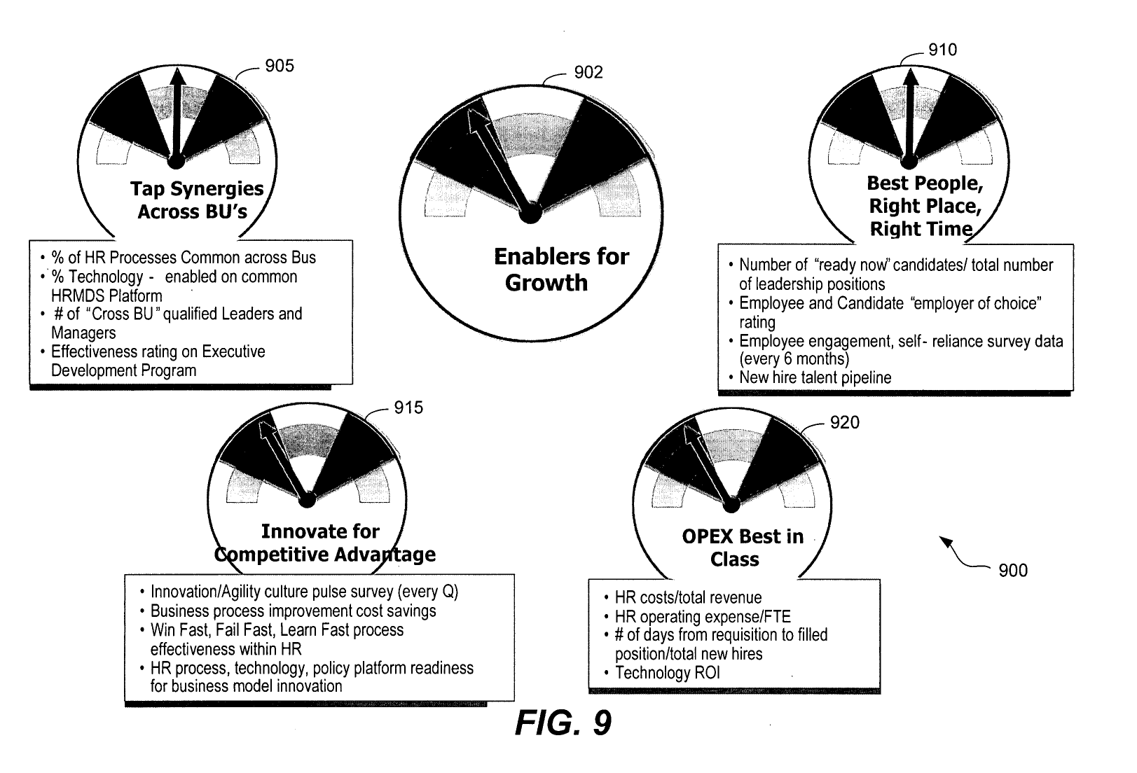

A graphic data representation of human capital metrics and other matrices can be generated on a suitable data processing apparatus of the present invention, as shown in FIG. 9, for instance, linking metrics to outcomes that support a client's business strategy. FIG. 9 shows a “dashboard” graphic representation of the matrices.

The dashboard in FIG. 9 shows four dials each corresponding to a core enabler for growth (aggregated as Strategic Thrusts) 902, and indicates how well the company is doing in each of these according to a color or other indicator. The core enablers in FIG. 9 are: Tap Synergies Across the BUs (Business Units) 905; Best People, Right Place, Right Time (i.e., getting competitive advantage through people) 910; Innovate for Corporate Advantage (i.e., gain competitive advantage by being able to innovate faster than their competitors) 915; and OPEX Best in Class (i.e., have their operating expenses at best in class levels) 920.

Below the strategic thrusts are the HR activities that relate to them; that is, there is a direct link between these activities and the strategic thrusts and the HCOM metric. Some of these are activities common across the business units, such as “Best People, Right Place, Right Time” 910. For this thrust the HR issues are: the number of ready now candidates/total number of leadership positions, employee and candidate, employer of choice rating and new hire talent pipeline. For the thrust “Innovate for Competitive Advantage” 915, the HR issues are culture, business process improvement cost savings, HR processes, technology, and policy platform readiness for business model innovation. Finally, in “OPEX Best in Class” 920, the HR issues that drive OPEX include HR costs/total revenue and HR operating expenses/FTE.

The HR issues are those areas that, in one example, HR determined could be done to contribute to the corporate growth objective. FIG. 9 illustrates what is possible with the dashboard using current HRIS data or data from the Enterprise Resource Planning (ERP) systems to develop, track and monitor the issues that are driving HCOM.

The focus on value and asking and answering data driven questions, in accordance with embodiments of the present invention, provides for determining the human capital return on an investment, the human capital impact on an acquisition, divestiture and downsizing decisions, and enabling of a company to fine tune a human capital strategy.

There is great potential for cost savings and revenue enhancements using human capital metrics for better management of business processes and functions. For instance, most conventional work done in outsourcing of HR functions has been focused on reducing HR administrative costs. Such costs include the administration of benefits and filing of government reports. HR administrative costs can also include capital, material, computers, and other purchases to support HR, such as consulting fees etc., as well as the HR information system. When the TCE is calculated, however, HR administrative costs often comprise only a small percentage of TCE (e.g., 2%). Thus, for example, while a 20-30% savings realized by outsourcing HR administration seems large, this savings is dwarfed by what can be done by better management of other components of TCE. For instance, a 25% reduction in HR administrative costs might generate $15 million in savings. However, 10% savings in post retirement and other benefits, along with a 5% improvement in employee productivity for the same wages paid, could result in over $200 million in cost improvements and revenue enhancements.

Human capital metrics have been shown to create organizational and operational improvements that lead to sustainable, increased earnings. In addition, having a metric that can be displayed across the organization and to the investment community is beneficial as it shows how human capital is managed, leading to the potential for increased stockholder value. Being seen as an innovative company has many advantages. Companies seek an innovation premium to their price-earnings ratio, leading to an increased valuation of the company in the securities market. A company that can more accurately and dependably measure and predict the costs and productivity of their human capital resources has a competitive advantage with customers, when hiring, when seeking outside services, and in being seen as a positive part of the communities in which they operate. In addition, securities analysts are interested in companies that are successfully introducing new management techniques.

Embodiments of the invention, including the methods, apparatus, platform, servers, modules, and engines described herein, can be implemented in digital electronic circuitry, or in computer hardware, firmware, software, or in combinations of them. Apparatus embodiments of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. Embodiments of the invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. A computer generally includes one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and Flash memory devices; magnetic disks such as internal hard disks and removable disks; magneto-optical disks; and CD-ROM disks. Any of the foregoing can be supplemented by, or incorporated in, ASICs (application-specific integrated circuits).

While the invention has been particularly shown and described with reference to specific embodiments thereof, it will be understood by those skilled in the art that changes in the form and details of the disclosed embodiments may be made without departing from the spirit or scope of the invention. The inventors contemplate the calculation of the cost of, and the value delivered by, human capital as having various forms in addition to the embodiments and examples set forth above. For instance, the measure of contribution serving as the numerator in an HCOM calculation may be another metric, including currently known metrics and metrics developed in the future. Also, human capital metrics are applicable to a wide variety of organizations and industries. For instance, human capital metrics have regulatory applications. In one embodiment, TCE and HCOM are calculated for and monitored by Public Utility Commissions (PUCs) in the fields of power generation or power distribution, and/or some combination thereof.

Additional embodiments are contemplated that leverage various data pools for analysis. For example, the Department of Commerce prepares data forecasting growth in different geographies that may be integrated with human capital metric calculations to increase the accuracy of forecasts. Also, the apparatus, modules, computers, and devices described herein may be connected to one another and to other devices through wired and wireless networks. Moreover, embodiments of the present invention may be employed with a variety of network protocols and architectures. Thus, the examples described herein are not intended to be limiting of the present invention. It is therefore intended that the appended claims will be interpreted to include all variations, equivalents, changes and modifications that fall within the true spirit and scope of the present invention.

What is claimed is:

1. A computer-implemented method of characterizing the financial state and performance of an organization by measuring the economic value of one or more persons to the organization, the method comprising:
accessing one or more data resources storing data associated with one or more persons;
selecting a plurality of fields of the data as cost data of the one or more persons, including direct expenses associated with the one or more persons and indirect expenses associated with the one or more persons;
retrieving the selected data from the one or more data resources;
calculating a human capital metric in accordance with the retrieved data, including summing the cost data to determine a total cost for the one or more persons;
generating a report including the calculated human capital metric; and
providing the report.

2. The method of claim 1, wherein calculating the human capital metric further includes:
retrieving a measure of contribution attributable to the one or more persons, and dividing the measure of contribution by the total cost to determine a human capital operating margin for the one or more persons.

3. The method of claim 2, wherein the measure of contribution is one selected from the group consisting of an operating income, a market value, and a negotiated transfer price.

4. The method of claim 1, wherein the data is accumulated over a designated timeframe.

5. The method of claim 1, wherein the direct expenses include one or more selected from the group consisting of cash remuneration, wages, variable pay, taxes, benefits costs, administrative costs, timing costs, development costs, recruitment costs, relocation costs, severance provisions, training costs, pension costs, and medical expenses.

6. The method of claim 1, wherein the indirect expenses include one or more selected from the group consisting of office supplies costs, printing costs, shipping costs, property maintenance, real estate costs, professional services, computing, communications, transportation costs, and entertainment costs.

7. The method of claim 1, wherein the cost data includes administrative costs associated with the one or more persons.

8. The method of claim 7, wherein the administrative costs include one or more selected from the group consisting of materials, services, and capital expenses.

9. The method of claim 1, further comprising:
identifying an attribute of the organization as a target for changing the financial state of the organization, in accordance with the calculated human capital metric.

10. The method of claim 9, wherein the identified attribute is one selected from the group consisting of remuneration, benefits, administrative aspects, training, pension, real estate, professional services, distributed computing, communications, transportation, and entertainment.

11. The method of claim 1, further comprising performing an intervention event.

12. The method of claim 11, wherein the intervention event is one selected from the group consisting of an investment, an acquisition, a divestiture, and a downsizing.

13. The method of claim 11, further comprising determining a business outcome in accordance with the intervention event.

14. The method of claim 1, wherein the one or more data resources include one selected from the group consisting of a human resources information system (HRIS), an HR database, and a financial database.

15. The method of claim 1, wherein the data includes one or more selected from the group consisting of employment information data, financial data, and general ledger data.

16. The method of claim 1, wherein the one or more persons include one selected from the group consisting of a worker, an employee, a contractor, an officer, and an agent.

17. The method of claim 1, wherein the report is a signal.

18. The method of claim 1, wherein the report is in a format selected from the group consisting of a compilation, a graph, and a financial statement component.

19. A computer-implemented method of characterizing the financial state and performance of an organization by comparing the economic value of persons in the organization, the method comprising:
accessing one or more data resources storing data associated with a first unit of one or more persons and a second unit of one or more persons;
selecting a plurality of fields of the data as first cost data of the first unit of one or more persons and second cost data of the second unit of one or more persons, including direct expenses associated with the one or more persons and indirect expenses associated with the one or more persons;
retrieving the selected data from the one or more data resources;
calculating a first human capital metric in accordance with the retrieved data, including summing the first cost data to determine a first total cost for the first unit of one or more persons;
calculating a second human capital metric in accordance with the retrieved data, including summing the second cost data to determine a second total cost for the second unit of one or more persons;
comparing the first human capital metric with the second human capital metric to determine comparison data;
generating a report including the comparison data; and
providing the report.

20. The method of claim 19, wherein calculating the first human capital metric further includes:
retrieving a first operating income attributable to the first unit of one or more persons, and dividing the first operating income by the first total cost to determine a first human capital operating margin.

21. The method of claim 19, wherein calculating the second human capital metric further includes:
retrieving a second operating income attributable to the second unit of one or more persons, and dividing the second operating income by the second total cost to determine a second human capital operating margin.

22. The method of claim 19, further comprising:
identifying an attribute of the first unit or the second unit as a target for changing the financial state of the organization, in accordance with the comparison data.

23. The method of claim 19, further comprising performing an intervention event.

24. The method of claim 23, wherein the intervention event includes allocating expenses between the first unit and the second unit.

25. The method of claim 19, wherein the first unit is one selected from the group consisting of a division, a department, a team, a group, a module, and a company.

26. An apparatus for characterizing the financial state and performance of an organization by measuring the economic value of one or more persons to the organization, the organization including one or more data resources storing data associated with one or more persons, the apparatus comprising:
a data collection module coupled to:
access the one or more data resources,
select a plurality of fields of the data as cost data of the one or more persons, including direct expenses associated with the one or more persons and indirect expenses associated with the one or more persons, and
retrieve the selected data from the one or more data resources;
an analysis module coupled to calculate a human capital metric in accordance with the retrieved data, including summing the cost data to determine a total cost for the one or more persons; and
a reporting module coupled to generating a report including the calculated human capital metric.

27. The apparatus of claim 26, wherein calculating the human capital metric further includes:
retrieving a measure of contribution attributable to the one or more persons, and dividing the measure of contribution by the total cost to determine a human capital operating margin for the one or more persons.

28. The apparatus of claim 27, wherein the measure of contribution is one selected from the group consisting of an operating income, a market value, and a negotiated transfer price.

29. The apparatus of claim 26, wherein the analysis module is situated on a first server.

30. The apparatus of claim 29, wherein the data collection module is situated on the first server.

31. The apparatus of claim 29, wherein the data collection module is situated on a second server in communication with the first server over a network.

32. The apparatus of claim 29, wherein the reporting module is situated on the first server.

33. The apparatus of claim 29, wherein the reporting module is situated on a second server in communication with the first server over a network.

34. A computer-implemented method of affecting the operation of an organization using financial state information as a measure of the economic value of one or more persons to the organization, the method comprising:
accessing one or more data resources storing data associated with one or more persons, the data including cost data for the one or more persons, including direct expenses and indirect expenses;
collecting the data from the one or more data resources, the data accumulated over a designated timeframe;
filtering the collected data, including extracting the cost data;
calculating a first human capital metric based the cost data, including summing the cost data to determine a total cost for the one or more persons;
calculating a second human capital metric based on the first human capital metric, including retrieving a measure of economic value attributable to the one or more persons, and dividing the measure by the total cost to determine a human capital operating margin for the one or more persons;
identifying an attribute of the organization as a target for changing the financial state of the organization, in accordance with the calculated first human capital metric or second human capital metric; and
performing an intervention event on the identified attribute of the organization.

35. The method of claim 34, further comprising:
outputting a report indicating the first human capital metric and the second human capital metric.

36. The method of claim 34, wherein the identified attribute is a business process.

37. The method of claim 34, wherein the identified attribute is the one or more persons.
